(19) United States
(12) Patent Application Publication
(10) Pub. No.: US 2008/0121447 A1
(43) Pub. Date: May 29, 2008

(54) Drive train for a motor vehicle having an internal combustion engine and an electric drive unit

(76) Inventors: Jurgen Lang, Backnang (DE); Klaus Riedl, Tubingen (DE)

Correspondence Address: KLAUS J. BACH, 4407 TWIN OAKS DRIVE, MURRYSVILLE, PA, 15668, US

(21) Appl. No.: 11/983,490

(22) Filed: Nov. 9, 2007

Related U.S. Application Data
(63) Continuation-in-part of application No. PCT/EP06/04215, filed on May 5, 2006.

(30) Foreign Application Priority Data
May 12, 2005 (DE) 10 2005 022 011.8

(51) Int. Cl. B60W 20/00; F16H 3/72; F16H 47/04; F16H 3/08; G06F 17/00

(52) U.S. Cl. 180/65.2; 475/5; 475/81; 475/249; 701/51; 903/918

(57) ABSTRACT

In a drive train for a motor vehicle provided with an internal combustion engine, an electric drive assembly and a transmission having a compact structural design and including at least six forward speeds, the transmission comprises an input-side planetary gear set and an output side Ravigneaux planetary gear, a sun wheel of the input side planetary gear set is fixed and the six forward gears and one reverse gear are adjustable by closing and opening, in pairs, various clutches and brakes.

This is a Continuation-In-Part Application of pending international patent application PCT/ep2006/004215 filed May 5, 2006 and claiming the priority of German patent application 10 2005 022011.8 filed May 25, 2005.

### BACKGROUND OF THE INVENTION

The present invention relates to a drivetrain for a motor vehicle having an internal combustion engine and an electric drive unit with a transmission having an input shaft with an input, side planetary gear set and an output shaft with an output side planetary gear set.

WO 2004098935 A1 describes a drivetrain for a motor vehicle having an internal combustion engine, two electric drive units and a transmission. The transmission has an input shaft, an input-side planetary gear set, two further planetary gear sets and an output shaft. A total of seven forward gears and three reverse gears can be set between the input shaft and output shaft by means of three clutches and four brakes. The first electric drive unit can selectively be connected to the input shaft or to the sun gear of the input-side planetary gear set. The second electric drive unit is directly connected to a motor shaft of the internal combustion engine. The motor shaft is connected by means of a starting clutch and the input shaft to a ring gear of the input-side planetary gear set so that a plurality of different operating strategies can be realized.

It is the object of the present invention to provide a drivetrain in which a compact design of the transmission is made possible while realizing at least six forward gears.

### SUMMARY OF THE INVENTION

In a drive train for a motor vehicle provided with an internal combustion engine, an electric drive assembly and a transmission having a compact structural design and including at least six forward speeds, the transmission comprises an input-side planetary gear set and an output side Ravigneaux planetary gear, a sun wheel of the input side planetary gear set is fixed and the six forward gears and one reverse gear are adjustable by closing and opening, in pairs, various clutches and brakes.

According to the invention, the output-side planetary gear set of the transmission is in the form of a Ravigneaux planetary gear set with a small sun gear, a large sun gear, a wide planet gear, a narrow planet gear with associated planet gear carriers, and a ring gear. The transmission has three clutches and at least two brakes. The input-side planetary gear set, the Ravigneaux planetary gear set, the clutches and brakes are arranged such that, in the event of a sun gear of the input-side planetary gear set being fixed relative to a housing by means of the pairwise closure of the clutches and/or brakes, it is possible to provide six different forward gear stages between the input shaft, which is connected to the internal combustion engine, and the output shaft. A transmission of such construction is known for example from EP 0 434 525 B1. If the sun gear of the input-side planetary gear set can be fixed by means of a brake relative to the housing, it is possible to set seven forward gears and one reverse gear in the transmission.

Only two planetary gear sets are therefore necessary in order to establish the gear stages. In addition, only a minimum number of clutches or brakes is necessary. It is therefore possible to achieve a particularly compact design of the transmission.

The electric drive unit can either be fixedly connected, or connectable by means of a clutch, to the input shaft. The electric drive unit can therefore impart an additional torque which acts together with the torque of the internal combustion engine. In addition, the electric drive unit can be operated as a generator in a regenerative mode, as a result of which excess energy can be converted into electrical energy and stored in a battery.

The electric drive unit can also be connected, or be connectable by means of a clutch, via a further input shaft of the transmission to the sun gear of the input-side planetary gear set. The input shaft which is connected to the internal combustion engine and the further input shaft are connected to different elements of the input-side planetary gear set, for example to the sun gear and the ring gear. Purely electric starting of the motor vehicle by means of the electric drive unit is therefore possible. In addition, the input-side planetary gear set can act as a superposition gearing in which the rotational movements of the internal combustion engine and of the electric drive unit are superposed. This permits, in addition to the fixed transmission ratios of the gears of the transmission, a continuously variable adjustment of the transmission ratio of the transmission. By closing different clutches and/or brakes in the transmission, it is possible in said described operating mode to provide for at least two different driving ranges with at least partially different transmission ratio ranges.

It is additionally thereby possible to design the drivetrain without a starting element, for example in the form of a starting clutch or a torque converter. By means of corresponding setting of the rotational speeds of the internal combustion engine and of the electric drive unit, it is possible to set a state at the input-side planetary gear set in which the movements of the two driven elements cancel one another out and the element via which the drive output to the Ravigneaux planetary gear set takes place is stationary. Said state is referred to as the geared neutral point. From said state, it is possible for the motor vehicle to be started from standstill by means of corresponding variation of the rotational speeds.

In order to assist said geared neutral starting, a freewheel can be arranged between the transmission and the internal combustion engine, which freewheel supports the motor shaft or input shaft with respect to the housing of the transmission in one rotational direction.

In one embodiment of the invention, the electric drive unit can be connected by means of a fourth clutch to the input shaft which is drive-connected to the internal combustion engine, and by means of a fifth clutch to the further input shaft. In addition, the sun gear of the input-side planetary gear set can be fixed by means of the first brake relative to the housing. The first brake is closed in particular when the electric drive unit is connected to the input shaft which is drive-connected to the internal combustion engine. The electric drive unit can therefore act selectively on both input shafts, which considerably increases the number of possible operating strategies.

In one embodiment of the invention, the drivetrain has a further electric drive unit which is connected, or can be connected by means of a clutch, to the input shaft to which the internal combustion engine is drive-connected. Said drive unit can likewise be operated either as a motor or as a generator. The further electric drive unit can in particular be connected or connectable to a motor shaft which is arranged between the internal combustion engine and the starting element or freewheel, and the electric drive unit can be connected or connectable to the input shaft between the starting element or freewheel and the transmission.

By using a further electric drive unit, it is possible to implement more operating strategies than if using only one electric drive unit.

In one embodiment of the invention, the drivetrain has a control device which is provided to carry out a start of the internal combustion engine by acting on the internal combustion engine with the drive output torque of the electric drive unit. For this purpose, the drive connection between the input shaft and the output shaft is interrupted. The drive connection is interrupted if none of the clutches or brakes or only one clutch or brake of the transmission is closed.

It is possible in particular for the torque of the electric drive unit to act on the internal combustion engine with the interposition of the input-side planetary gear set.

The drivetrain can also have a further start device, such as for example a starter or starter-generator which is connected to the internal combustion engine by means of a belt. In said case, the start of the internal combustion engine can also take place by means of said further start device.

The control device can also be provided to carry out the start of the internal combustion engine by acting on the internal combustion engine with the drive output torque of the further electric drive unit with an interrupted drive connection between the motor shaft and the output shaft. The drive connection is for example interrupted when the drive connection is interrupted within an existing starting element, for example a clutch, or when the drive connection is interrupted between the input shaft and the output shaft.

The control device can also be provided to carry out a start of the internal combustion engine by acting on the internal combustion engine with the drive output torque of the electric drive unit and of the further electric drive unit. In this case, the output torques of the two electric drive units are superposed, and a particularly high torque can be provided for starting the internal combustion engine.

It is possible in particular for the torque of the electric drive unit to act on the internal combustion engine with the interposition of the input-side planetary gear set. It is hereby possible for the drive output torque of the second electric drive unit to be stepped up in the direction of the internal combustion engine, as a result of which a further increased torque can be provided for the starting of the internal combustion engine.

In one embodiment of the invention, the control device is provided to select one of said start methods according to the operating conditions of the drivetrain. The operating conditions are for example an operating temperature or operating duration of the drivetrain, an operating temperature or operational frequency or a wear state of a starting element, a clutch or a brake, a charging state of a battery, a detected driving environment or a driver demand.

The invention will become more readily apparent from the following description of exemplary embodiments thereof illustrated in simplified form in the accompanying drawings:

### BRIEF DESCRIPTION OF THE DRAWINGS

FIG. 1 shows a diagrammatic illustration of a drivetrain of a motor vehicle having an internal combustion engine, two electric drive units, a starting element and a transmission,

FIG. 2 shows a table for the clutches and brakes which are active in the various gears of the transmission of FIG. 1,

FIG. 3 shows a diagrammatic illustration of a drivetrain of a motor vehicle in a second embodiment,

FIG. 4 shows a diagrammatic illustration of a drivetrain of a motor vehicle in a third embodiment,

FIG. 5 shows a diagrammatic illustration of a drivetrain of a motor vehicle in a fourth embodiment,

FIG. 6 shows a diagrammatic illustration of a drivetrain of a motor vehicle in a fifth embodiment with only one electric drive unit,

FIG. 7 shows a diagrammatic illustration of a drivetrain of a motor vehicle in a sixth embodiment,

FIG. 8 shows a diagrammatic illustration of a drivetrain of a motor vehicle in a seventh embodiment, and

FIG. 9 shows a diagrammatic illustration of a drivetrain of a motor vehicle in an eighth embodiment without a starting element.

### DESCRIPTION OF THE VARIOUS EMBODIMENTS

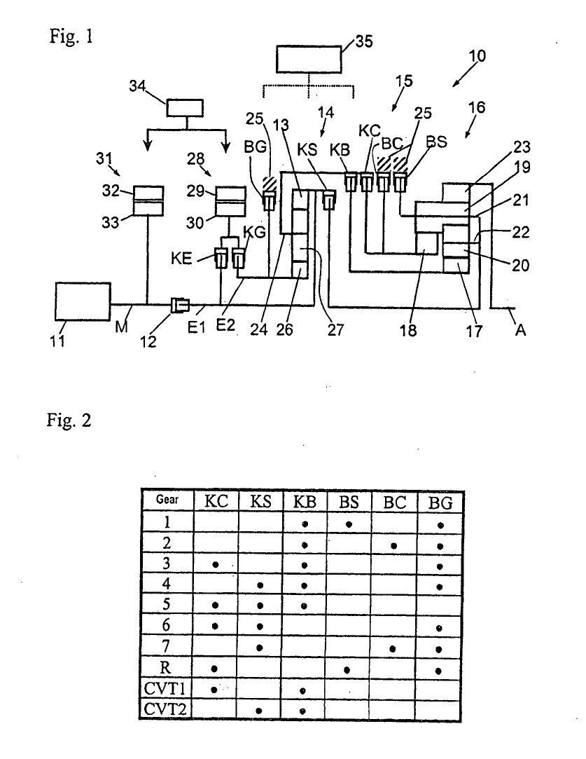

According to FIG. 1, a drivetrain 10 has an internal combustion engine 11 which is connected by means of a motor shaft M, a starting element in the form of a wet starting clutch 12 and a first input shaft E1 to a ring gear 13 of an input-side planetary gear set 14 of a transmission 15. In addition to the input-side planetary gear set 14, the transmission 15 has an output-side planetary gear set in the form of a Ravigneaux planetary gear set 16. The Ravigneaux planetary gear set 16 has a small sun gear 17, a large sun gear 18, a wide planet gear 19, a narrow planet gear 20 with associated planet gear carriers 21, 22, and a ring gear 23. The wide planet gear 19 meshes with the large sun gear 18 and the ring gear 23. The narrow planet gear 20 meshes with the small sun gear 17 and with the wide planet gear 19. The planet gear carriers 21 and 22 are coupled to one another. The ring gear 23 is connected to an output shaft A which is connected by means of a differential gearing (not illustrated) to vehicle wheels (not illustrated).

The ring gear 13 of the input-side planetary gear set 14 can be connected by means of a first clutch KS to the planet gear carriers 21, 22 of the Ravigneaux planetary gear set 16. A planet gear carrier 24 of the input-side planetary gear set 14 can be connected by means of a second clutch KB to the small sun gear 17 of the Ravigneaux planetary gear set 16 and by means of a third clutch KC to the large sun gear 18 of the Ravigneaux planetary gear set 16. The large sun gear 18 of the Ravigneaux planetary gear set 16 can be fixed by means of a second brake BC, and the planet gear carriers 21, 22 by means of a third brake BS, relative to a housing 25.

A sun gear 26 of the input-side planetary gear set 14 is connected to a further input shaft E2. The sun gear 26 can be fixed by means of the further input shaft E2 and a first brake BG relative to the housing 25. The input-side planetary gear set 14 additionally has a planet gear 27 which is mounted on the planet gear carrier 24 and which meshes with the sun gear 26 and the ring gear 13.

The drivetrain 10 has an electric drive unit 28 with a housing-mounted stator 29 which interacts with a rotor 30 in order to generate a drive torque and/or to recover electrical energy. The rotor 30 can be connected by means of a fourth clutch KE to the input shaft E1 and by means of a fifth clutch KG to the further input shaft E2.

The drivetrain 10 additionally has a further electric drive unit 31 which likewise has a stator 32 and a rotor 33. The rotor 33 is connected to the motor shaft M.

The two electric drive units 28 and 31 are connected to a battery 34. The battery 34 supplies the electric drive units 28 and 31 with electrical energy in order to generate a drive torque, and receives electrical energy if one or both electric drive units 28 and/or 31 are operated in the regenerative mode, that is to say as a generator.

The internal combustion engine 11, the starting clutch 12, the transmission 15 and the electric drive units 28 and 31 are actuated by a control device 35. For reasons of clarity, the signal lines to said components are not illustrated.

In the transmission 15, it is possible for seven forward gears and one reverse gear to be set between the input shaft E1 and the output shaft A. If the sun gear 26 of the input-side planetary gear set 14 is fixed by means of the brake BG relative to the housing, then six forward gears and one reverse gear can be formed by the pairwise closure of the clutches KS, KB, KC and brakes BC and BS. When the brake BG is open and the clutches KS, KB, KC are simultaneously closed, a further gear is generated in which both planetary gear sets 14 and 16 rotate as a block, so as to give a transmission ratio of 1.

The table illustrated in FIG. 2 shows the closed clutches and brakes for each gear:

1st Gear:

In 1st gear, the brake BG is closed, so that the sun gear 26 of the input-side planetary gear set 14 is fixed relative to the housing 25. In addition, the clutch KB and the brake BS are closed. The drive therefore takes place via the ring gear 13 and the planet gear carrier 24 to the small sun gear 17. Since the planet gear carriers 21 and 22 are fixed by means of the brake BS, the ring gear 23 and therefore the output shaft A are driven by means of the narrow planet gear 20 and the wide planet gear 19.

2nd Gear:

In 2nd gear, the brake BG is likewise closed. In addition, the clutch KB and the brake BC are closed. The drive therefore takes place via the ring gear 13 and the planet gear carrier 24 to the small sun gear 17. The large sun gear 18 is stationary, so that the planet gear carriers 21 and 22 rotate, and the drive thus takes place to the ring gear 23.

3rd Gear:

In 3rd gear, the brake BG is likewise closed. In addition, the clutches KB and KC are closed. The drive therefore takes place via the ring gear 13 and the planet gear carrier 24 to the small sun gear 17 and the large sun gear 18. As a result, the Ravigneaux planetary gear set 16 rotates as a block.

4th Gear:

In 4th gear, the brake BG is likewise closed. In addition, the clutches KS and KB are closed. The drive therefore takes place both via the ring gear 13 and the planet gear carrier 24 to the small sun gear 17 and also directly to the planet gear carriers 21 and 22.

5th Gear:

In 5th gear, the brake BG is open and all the clutches KS, KB, KC are closed. Both planetary gear sets 14 and 16 therefore rotate as a block. This is referred to as the so-called direct gear. For this purpose, the clutch KG is open, so that the sun gear 26 can freely rotate. Alternatively, the electric drive unit 28 can also be actuated so as not to absorb or output any torque.

6th Gear:

In 6th gear, the brake BG is likewise closed. In addition, the clutches KC and KS are closed. The drive therefore takes place both via the ring gear 13 and the planet gear carrier 24 to the large sun gear 18 and also directly to the planet gear carriers 21 and 22.

7th Gear:

In 7th gear, the brake BG is likewise closed. In addition, the clutch KS and the brake BC are closed. The drive therefore takes place directly to the planet gear carriers 21 and 22. The large sun gear 18 is stationary, so that the planet gear carriers 21 and 22 rotate, and the drive thus takes place to the ring gear 23.

Reverse Gear:

In reverse gear, the brake BG is likewise closed. In addition, the clutch KC and the brake BS are closed. The drive therefore takes place via the ring gear 13 and the planet gear carrier 24 to the large sun gear 18. The planet gear carriers 21 and 22 are stationary, so that the ring gear 23 is driven by the wide planet gear 19, with a rotational direction reversal taking place.

### Operating States of the Drivetrain

a) Standstill of the Vehicle

When the internal combustion engine 11 is switched off and the electric drive units 28, 31 are deactivated, all the clutches and brakes are open.

For a warm start of the internal combustion engine 11, the latter is cranked by means of the further electric drive unit 31, which in this case outputs power. The rotational speed of the internal combustion engine 11 is between zero and the idle rotational speed. The starting clutch 12 is open here, as a result of which the drive connection between the motor shaft M and the drive output shaft A is interrupted.

For a cold start of the internal combustion engine 11, the latter is cranked by means of a combination of the electric drive units 28, 31, with the electric drive units 28, 31 outputting power. The rotational speed of the internal combustion engine 11 is between zero and the idle rotational speed. For said operating state, the starting clutch 12 and the clutch KE are closed, while the rest of the clutches KG, KS, KB and brakes BG, BC, BS are open.

The internal combustion engine 11 can also be started by being acted on by both electric drive units 28, 31 with the interposition of the input planetary gear set 14. The rotational speeds and rotational directions of the electric drive units 28, 31 must be correspondingly adapted. Here, the starting clutch 12 and the clutches and brakes KG, KC and BC are closed, while the rest of the clutches and brakes are open.

The internal combustion engine 11 can also be started by being acted on only by the electric drive unit 28 with the interposition of the input planetary gear set 14. Here, the starting clutch 12 and the clutches and brakes KG, KC and BC are closed, while the rest of the clutches and brakes are open.

b) Conventional Operation with Only the Internal Combustion Engine

The starting clutch 12 is closed, while the clutches KE, KG are open. The position of the rest of the clutches and brakes results from the comments regarding the shifting of the transmission to realize the individual gears, see above.

When the clutches KE, KG are open, the drag losses of the electric drive unit 28 can be kept low since the latter is coupled to one of the input shafts E1, E2 only if this is absolutely necessary.

c) Dual Operation of the Internal Combustion Engine with the Electric Drive Unit

For starting and for driving in gears 1 to 7 and the reverse gear R, the rotational speed of the electric drive unit 28 corresponds to the rotational speed of the input shaft E1. An additional torque can be fed in by means of the electric drive units 28, 31. Alternatively, one electric drive unit 28, 31 or both drive units can be operated in the generator mode in order to reclaim energy. For all of said gears, the starting clutch 12 and the clutch KE are closed, while the clutch KG is open. The state of the rest of the clutches and brakes results from the comments regarding the shifting of the transmission to realize the individual gears, see above.

d) Dual Operation of the Internal Combustion Engine with the Electric Drive Unit Including the Assurance of a Geared, Neutral Function

In said state, a standstill of the vehicle is ensured as a result of a geared neutral function. In said state, the internal combustion engine 11 is operated with a rotational speed greater than, or equal to, the idle rotational speed. The further electric drive unit 31 can then deliver a positive or negative drive output torque. In said state, the electric drive unit 28 rotates with a rotational speed which corresponds to the geared neutral point. The drive output torque of the electric drive unit 28 is in a fixed ratio, which is predetermined by the geometric ratios of the input-side planetary gear set 14, to the torque which is introduced, on the input shaft E1, by the internal combustion engine and by the further electric drive unit 31 via the ring gear 13 into the input-side planetary gear set 14. While the starting clutch 12, the clutches KG, KB and the brake BS are closed, the rest of the clutches and brakes are open. The rotational speed of the electric drive unit 28 required for the geared neutral point results from the ratio of the diameter of the sun gear 26 to the diameter of the ring gear 13 of the input-side planetary gear set 14.

With an unchanged position of the clutches and brakes, a reduction or increase in the rotational speed of the electric drive unit 28 results in forward or reverse travel.

e) Electric Driving

With the internal combustion engine 11 deactivated and with the further electric drive unit 31 deactivated, an operating mode of the drivetrain 10 can be established only by means of the electric drive unit 28.

Starting and driving in gears 1 to 7 and in the reverse gear R takes place by means of suitable power supply to the electric drive unit 28, with the latter either delivering a drive torque or feeding power into the battery 34 in the generator mode. For said driving states, the starting clutch 12 and the clutch KG are open, and the clutch KE is closed. The state of the rest of the clutches and brakes results from the comments regarding the shifting of the transmission to realize the individual gears, see above.

By means of the above-specified different operating states of the drivetrain 10, it is possible for identical or comparable driving states of the motor vehicle to be obtained in different ways. A selection of a suitable operating state for a desired driving state takes place for example on the basis of a performance graph, which contains for example efficiencies, power balances, obtainable acceleration values or the like. A selection of a suitable operating state can for example take place according to an operating strategy which is predefined a priori. Alternatively or in addition, individual operating variables of the drivetrain such as operating temperatures of drive units 28, 31 or clutches and brakes can be monitored, so that, in the event of a limit value of an operating temperature being exceeded, a clutch can be deactivated by changing an operating state of the drivetrain, so that said clutch or an associated drive unit is relieved of load. Alternatively or in addition, it is possible for the charging state of the battery 34 to be incorporated in the selection of the operating state.

The illustrated drivetrain 10 permits hybrid operation with seven forward gears and one reverse gear being provided in addition to the hybrid operation, while ensuring high transmissible drive output torques. The starting clutch 12 can be a dry or wet clutch with partial or full starting functionality. Alternatively, the starting clutch 12 can, as a result of the embodiment according to the invention, be of smaller dimensions, since for the different possible starting operating states and the electric assistance of the drivetrain downstream of the starting clutch 12, the starting clutch 12 is (at least at times) subjected to relatively low loadings. If the starting clutch 12 is overloaded, then the latter can be relieved of load by starting by means of an electric drive unit without said starting clutch 12.

The second electric drive unit 32 is preferably a high-torque low-speed motor, while the first electric drive unit delivers a relatively low torque at high rotational speeds.

f) Continuously Variable Driving Operation with Two Different Driving Mode Ranges

According to a further proposal of the invention, a continuously variable transmission ratio with two driving ranges is made possible. Here, the continuously variable transmission ratio is generated in particular by means of a superposition of the drives
by the electric drive unit 28 and
by the internal combustion engine 11 and/or the further electric drive unit 31
   by means of the input-side planetary gear set 14, with a transmission of torque to the Ravigneaux planetary gear set 16 taking place in a first driving range via the planet gear carrier 24 to the small sun gear 17 and the large sun gear 18, and in a second driving range via the planet gear carrier 24 to the small sun gear 17 and via the clutch KS to the planet gear carriers 21, 22. The first driving range is denoted in the table in FIG. 1 as CVT1 and the second driving range as CVT2.

In the first driving range, the clutches KC and KB and the starting clutch 12 are closed. The first driving range is preferably assigned driving speeds from −x above zero to +x, with it being possible for the reverse gear speed to be limited by the control device 35. The first driving range is preferably assigned speeds of (−75 km/h) −30 km/h to +75 km/h. The maximum drive output torque is limited, depending on the design and interaction of the electric drive unit 28 and the internal combustion engine 11, by one of said two units, and is for example 1300 Nm, in particular in the range between 10 km/h and 40 km/h.

In the second driving range, the clutches KS and KB and the starting clutch 12 are closed. The second driving range is preferably assigned higher driving speeds (for example from approximately 40 km/h to +300 km/h). The maximum drive output torque is lower than in the first driving range, for example 440 Nm in the range between 50 km/h and 250 km/h.

A switch between the two driving ranges takes place when the rotational speed of the input shaft E1 and the electric drive unit 28 have the same rotational speeds in both driving ranges. For such a change from one driving range into the other driving range, no acceleration or deceleration of the inertial masses is necessary.

For driving operation, individual operating modes of the drivetrain are permitted, with it being possible for said operating modes in their entirety or for only parts of the individual operating modes to be utilized. The drivetrain is preferably used
as an automatic multi-step unit, with in each case one gear constituting one operating mode,
as a continuously variable transmission in a first driving range,
as a continuously variable transmission in a second driving range.

Further possible operating modes are made possible according to the invention as follows:
In partial operating ranges with maximum power demand, drive takes place by means of the internal combustion engine 11, the electric drive unit 28 and—if present—the further electric drive unit 31.
In partial operating ranges in which there is neither an increased power demand nor is there a need for energy to be recovered by means of the electric drive units 28, 31, drive takes place exclusively by means of the internal combustion engine 11.
In order to recover energy, for example in order to recharge a battery 34, the energy is fed back into the battery 34 by means of the electric drive unit 28 and/or the further electric drive unit 31 when drive takes place by means of the internal combustion engine 11.

In partial operating ranges, it is also possible for drive to take place by means of the internal combustion engine 11 and the electric drive unit 28, with the electric drive unit 28 being fed at least partially by the further electric drive unit 31 used in the generator mode. This relieves the battery 34 of load and/or permits longer operation when the battery 34 is used.

Further possible operating modes are starting an internal combustion engine 11, in particular in a selective manner alternatively or cumulatively by means of the further electric drive unit 31 and/or the electric drive unit 28. A further possible operating mode relates to the utilization of the drive unit 28 and/or the further electric drive unit 31 for recovering energy or feeding energy back into the battery 34. Other possible operating modes result from the previously illustrated operating states a) to e).

A selection of individual operating modes takes place according to a driving strategy which is stored in particular in the control device 35. The driving strategy here includes in particular a selection of an operating mode according to
a charging state of the battery 34,
at least one environmental parameter such as a gradient, a geodetic height, a temperature or the like,
a vehicle parameter such as for example a load state, an operating temperature or an operating duration of the drivetrain or of a drive unit, an operating temperature or an operational frequency or a wear state of a starting element, a clutch or a brake,
at least one movement variable such as the vehicle speed or the vehicle acceleration,
at least one variable which is dependent on a driver, such as a pedal actuation (acceleration request, brake pedal), a manual actuation (manual selection of different transmission programs) and/or a driver type which is determined,
a characteristic map which contains, for example, efficiencies, power balances, obtainable acceleration values or the like,
an operating strategy which is predefined a priori, or
emission values (internal combustion engine or catalytic converter cold/warm),
   wherein the abovementioned influencing parameters may be a current parameter, chronologically previous parameters and/or an averaged parameter.

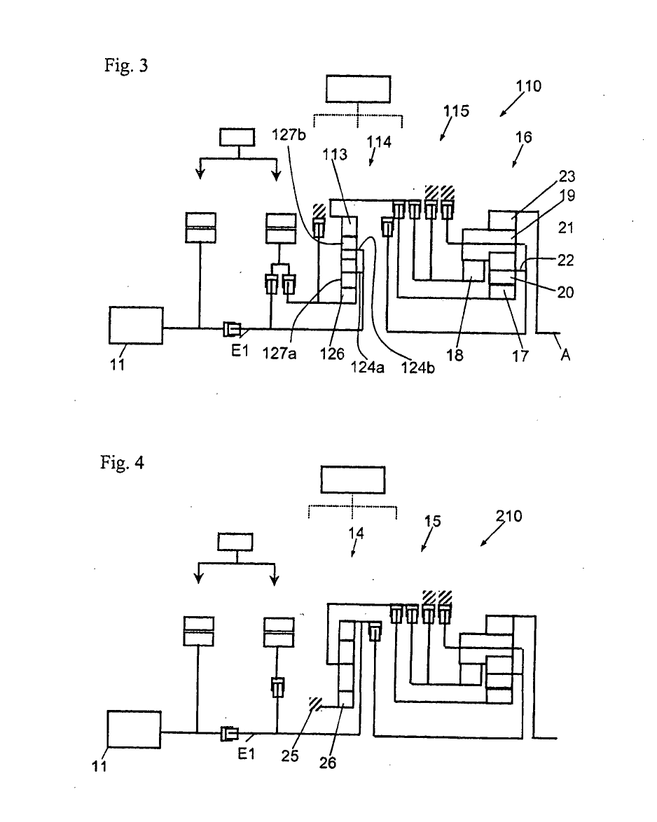

FIGS. 3 to 7 show drivetrains according to the invention in alternative embodiments. Components which are identical to those in FIG. 1 are provided here with the same reference symbols. In each case only the differences between the drivetrains are discussed below.

A drivetrain 110 as per FIG. 3 differs from the drivetrain 10 from FIG. 1 in that an input-side planetary gear set 114 of a transmission 115 is embodied as a double planetary gear set. The planetary gear set 114 has two planet gears 127a and 127b which are mounted on coupled planet gear carriers 124a, 124b. The inner planet gear 127a meshes with a sun gear 126 and the outer planet gear 127b. The outer planet gear 127b meshes in addition with a ring gear 113. The planet gear carriers 124a, 124b are connected to the input shaft E1 which can be drive-connected to the internal combustion engine 11. The drive output to the Ravigneaux planetary gear set 16 takes place via the ring gear 113.

The individual gears of the transmission 115 are likewise set corresponding to the table in FIG. 2. The same operating modes can be set with the drivetrain 110 as can be set with the drivetrain 10.

The transmission 115 has a greater transmission-ratio spread than the transmission 15 of FIG. 1.

A drivetrain 210 as per FIG. 4 differs from the drivetrain 10 of FIG. 1 in that the drivetrain 210 has only one input shaft E1 which can be drive-connected to the internal combustion engine 11. The sun gear 26 of the input-side planetary gear set 14 is fixedly connected to the housing 25, as a result of which the clutch KB is omitted. The 5th gear in the transmission 15 therefore cannot be realized. In addition, no continuously variable operation and no geared neutral starting is possible. The internal combustion engine 11 can be started only without the interposition of the input-side planetary gear set 14. All the other described operating modes can likewise be implemented with the drivetrain 210.

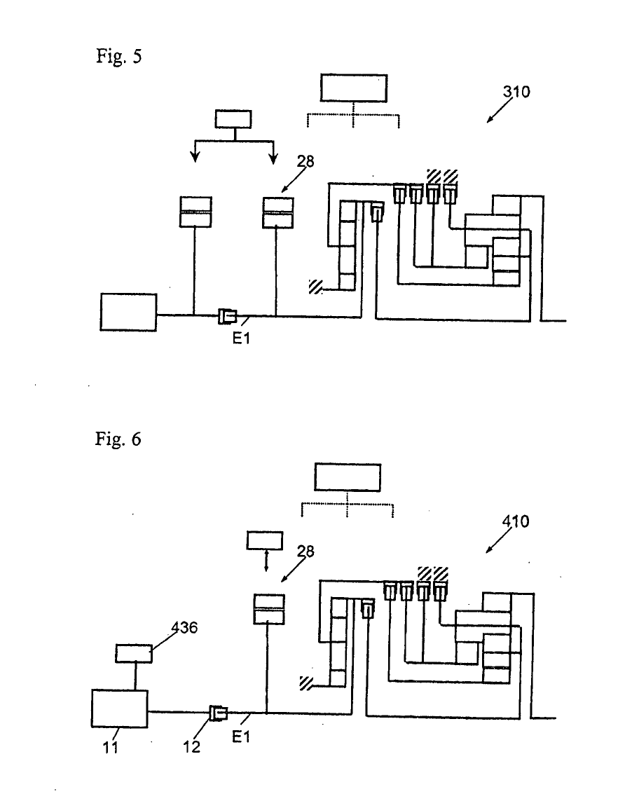

A drivetrain 310 as per FIG. 5 differs from the drivetrain 210 of FIG. 4 in that the electric drive unit 28 is fixedly connected to the input shaft E1. The electric drive unit 28 therefore cannot be decoupled from the input shaft E1.

A drivetrain 410 as per FIG. 6 differs from the drivetrain 310 of FIG. 5 in that the drivetrain 410 has only one electric drive unit 28 which is fixedly connected to the input shaft E1. The operating modes which require a second electric drive unit therefore cannot be realized.

The internal combustion engine 11 is connected to a start device in the form of a starter 436 as is known per se. The internal combustion engine 11 can be started either by means of the starter 436 or—as described above—by means of the electric drive unit 28.

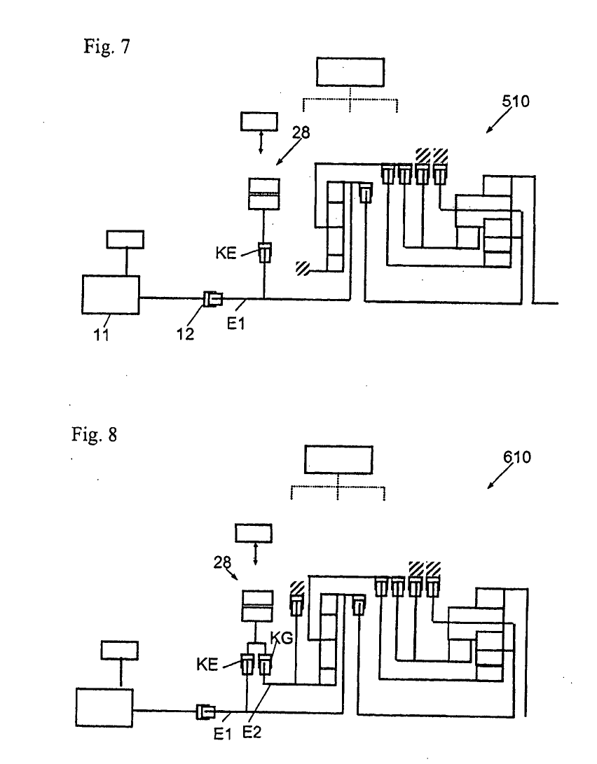

A drivetrain 510 as per FIG. 7 differs from the drivetrain 410 of FIG. 6 in that the electric drive unit 28 can be coupled by means of a clutch KE to the input shaft E1. The electric drive unit 28 can therefore be decoupled from the input shaft E1 in operating ranges in which there is neither a need for an additional torque nor for energy to be recovered. Drag losses in the electric drive unit 28 can therefore be avoided. This is advantageous in particular at high rotational speeds of the input shaft E1. Since internal combustion engines which operate on the Otto cycle are usually operated at higher rotational speeds and also have higher maximum rotational speeds than diesel engines, said embodiment is advantageous in particular in combination with an Otto engine.

A drivetrain 610 as per FIG. 8 differs from the drivetrain 10 of FIG. 1 in that the drivetrain 610 has only one electric drive unit 28 which can be connected by means of the clutch KE to the input shaft E1 and by means of the clutch KG to the further input shaft E2. Continuously variable operation and geared neutral starting is therefore still possible.

In a further embodiment of the invention, it is also possible that the electric drive unit 28 cannot be connected to the input shaft E1.

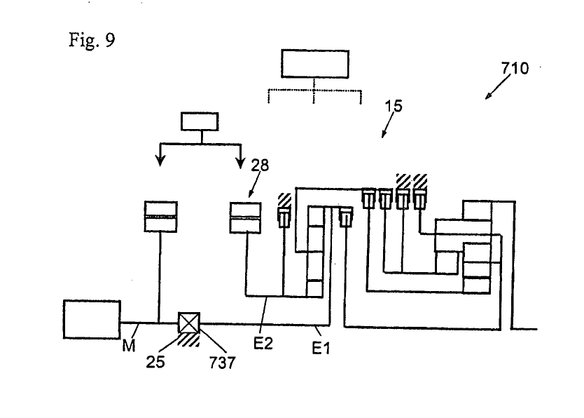

A drivetrain 710 as per FIG. 9 differs from the drivetrain 10 of FIG. 1 in that a freewheel 737 is provided instead of the starting clutch, which freewheel 737 supports the motor shaft M or the input shaft E1 with respect to the housing 25 of the transmission 15 in one rotational direction. In addition, the electric drive unit 28 is fixedly connected to the second input shaft E2 without the interposition of a clutch. There is no possibility of connecting the electric drive unit 28 to the input shaft E1. Only geared neutral starting or electric starting of the motor vehicle is therefore possible.

The replacement of the starting clutch by a freewheel is possible in all drivetrains in which the transmission has two input shafts.

In the described drivetrains as per FIGS. 4-9, it is also possible in each case for a double planetary gear set as in the drivetrain 210 from FIG. 3 to be used.

What is claimed is:

1. A drivetrain for a motor vehicle having an internal combustion engine (11),
a transmission housing (25) with a transmission (15, 115) which has at least one input shaft (E1) drive-connected to the engine (11), an input-side planetary gear set (14, 114), in the form of a double planetary gear set including a sun gear (126) an inner planet gear (127a) and an outer planet gear (127b) which are arranged on coupled planet gear carriers (124a, 124b), with the inner planet gear (127a) meshing with the sun gear (126) and the outer planet gear (127b) meshing with the ring gear (113), an output-side Ravigneau planetary gear set (16) and an output shaft (A), with the input shaft (E1) being connected to an element (26, 124a, 124b) of the input-side planetary gear set (14, 114), and a further element (24, 126) of the input-side planetary gear set (14, 114) being connectable, by means of the output-side planetary gear set (16), to the output shaft (A), and
an electric drive unit (28) connected to an element (13, 26, 124a, 124b, 126) of the input-side planetary gear set (14, 114),
said Ravigneaux planetary gear set (16) including a small sun gear (17), a large sun gear (18), a wide planet gear (19), a narrow planet gear (20) with associated planet gear carriers (21, 22), and a ring gear (23), and the transmission (15, 115) having three clutches (KC, KS, KB) and two brakes (BS, BC), with the input-side planetary gear set (14, 114), the Ravigneaux planetary gear set (16), the clutches (KC, KS, KB) and brakes (BS, BC) being arranged such that, when a sun gear (26, 126) of the input-side planetary gear set (14, 114) is fixed relative to a housing (25) by means of the pairwise closure of at least one of the clutches (KC, KS, KB) and the brakes (BS, BC), six different forward gears are available to be established between the input shaft (E1), which is connected to the internal combustion engine (11), and the output shaft (A),
said input shaft (E1) which is drive-connected to the internal combustion engine (11) being connected to the planet gear carriers (124a, 124b) of the input-side planetary gear set (114) and connectable by means of a first clutch (KS) to the planet gear carriers (21, 22) of the Ravigneaux planetary gear set (16),
the sun gear (126) of the input-side planetary gear set (114) being lockable relative to a housing (25) by means of a first brake (BG),
the ring gear (113) of the input-side planetary gear set (114) being connectable by means of a second clutch (KB) to the small sun gear (17) of the Ravigneaux planetary gear set (16) and by means of a third clutch (KC) to the large sun gear (18) of the Ravigneaux planetary gear set (16),
the large sun gear (18) of the Ravigneaux planetary gear set (16) being lockable by means of a second brake (BC) relative to the housing (25),
the planet gear carriers (21, 22) of the Ravigneaux planetary gear set (16) can being lockable by means of a third brake (BS) relative to the housing (25),
the wide planet gear (19) of the Ravigneaux planetary gear set (16) meshing with the large sun gear (18) and the ring gear (23),
the narrow planet gear (20) of the Ravigneaux planetary gear set (16) meshing with the small sun gear (17) and the wide planet gear (19), and
the ring gear (23) of the Ravigneaux planetary gear set (16) being connected to the output shaft (A).

2. The drivetrain as claimed in claim 1, wherein the electric drive unit (28) is connectable to the input shaft (E1) which is drive-connected to the internal combustion engine (11).

3. The drivetrain as claimed in claim 1, wherein the transmission (15, 115) has a further input shaft (E2) which is connected to the sun gear (26, 126) of the input-side planetary gear set (14, 114), and the electric drive unit (28) is connectable to the further input shaft (E2).

4. The drivetrain as claimed in claim 1, wherein a starting element (12) is arranged between the internal combustion engine (11) and the transmission (15, 115).

5. The drivetrain as claimed in claim 3, wherein a freewheel (737) is arranged between the internal combustion engine (11) and the transmission (15).

6. The drivetrain as claimed in claim 3, including an operating mode in which a continuously variable transmission ratio can be set within the transmission (15, 115), with said operating mode having at least two driving ranges.

7. The drivetrain as claimed in claim 6, wherein
the first driving range is established by closing the second and third clutches (KB, KC) and
the second driving range is established by closing the first and second clutches (KS, KB).

8. The drivetrain as claimed in claim 1, wherein
the electric drive unit (28) is connectable by means of a fourth clutch (KE) to the input shaft (E1) which is drive-connected to the internal combustion engine (11),
the electric drive unit (28) is connectable by means of a fifth clutch (KG) to the further input shaft (E2) and
the sun gear (26, 126) of the input-side planetary gear set (14, 114) is lockable by means of the first brake (BG) relative to the housing (25).

9. The drivetrain as claimed in claim 1, wherein a further electric drive unit (31) is provided which is connectable to the input shaft (E1) that is drive-connected to the internal combustion engine (11).

10. The drivetrain as claimed in claim 9, wherein the further electric drive unit (31) is connectable to a motor shaft (M) which is arranged between the internal combustion engine (11) and the starting element (12) or freewheel (737), and the electric drive unit (28) is connectable to the input shaft (E1) between the starting element (12) or freewheel (737) and the transmission (15, 115).

11. The drivetrain as claimed in claim 1, wherein a control device (35) is provided for carrying out a start of the internal combustion engine (11) by acting on the internal combustion engine (11) with the drive output torque of the electric drive unit (28) with the drive connection between the input shaft (E1) and output shaft (A) being interrupted.

12. The drivetrain as claimed in claim 11, wherein the control device (35) is capable of carrying out a start of the internal combustion engine (11) by acting on the internal combustion engine (11) with the drive output torque of the electric drive unit (28) via the input-side planetary gear set (14, 114),

13. The drivetrain as claimed in claim 1, wherein a further start device (436) is connected to the engine by means of which the internal combustion engine (11) can be started.

14. The drivetrain as claimed in claim 9, wherein the control device (35) includes means for carrying out a start of the internal combustion engine (11) by acting on the internal combustion engine (11) with the drive output torque of the further electric drive unit (31) with the drive connection between the motor shaft (M) and the output shaft (A) interrupted.

15. The drivetrain as claimed in claim 9, wherein the control device (35) includes means for carrying out a start of the internal combustion engine (11) by acting on the internal combustion engine (11) with the drive output torque of the electric drive unit (28) and of the further electric drive unit (31).

16. The drivetrain as claimed in claim 11, wherein the control device (35) includes means for carrying out a start of the internal combustion engine (11) by acting on the internal combustion engine (11) with the drive output torque of the electric drive unit (28) via the input-side planetary gear set (14, 114), and of the further electric drive unit (31).

17. The drivetrain as claimed in claim 11, wherein the control device (35) includes means for selecting a start method for the internal combustion engine (11) according to the operating conditions of the drivetrain (10, 110, 210, 310, 410, 510).
